(19) United States
(12) Patent Application Publication
(10) Pub. No.: US 2019/0131032 A1
(43) Pub. Date: May 2, 2019

(54) COMMUNICATION ELECTRIC WIRE AND WIRE HARNESS

(71) Applicant: YAZAKI CORPORATION, Tokyo (JP)

(72) Inventors: Yurie Takayama, Shizuoka (JP); Daisuke Yagi, Shizuoka (JP)

(21) Appl. No.: 16/175,755

(22) Filed: Oct. 30, 2018

(30) Foreign Application Priority Data
Oct. 31, 2017 (JP) 2017-210791

(51) Int. Cl. H01B 7/18; H01B 7/00; H01B 11/02

(52) U.S. Cl. CPC H01B 7/18; H01B 11/02; H01B 7/0045

(57) ABSTRACT

A communication electric wire (1) includes a twisted pair wire (10) having a pair of conductor core wires (11) spirally bundled together and a protection layer (20) formed from resin and cylindrically covering an outer circumference of the twisted pair wire (10). The twisted pair wire (10) contacts an inner face of the protection layer (20) to eliminate its relative movement with respect to the protection layer (20) in the direction orthogonal to the axial line of the communication electric wire (1). The protection layer (20) is configured to have a specific ratio of 1 or more. The specific ratio is a ratio (c/D) of a thickness (c) of a portion where the protection layer (20) having the smallest thickness in a cross section orthogonal to the axial line of the communication electric wire (1) to a distance (D) between centers of the pair of the conductor core wires (11).

### CROSS-REFERENCES TO RELATED APPLICATION(S)

This application is based on and claims priority from Japanese Patent Application No. 2017-210791 filed on Oct. 31, 2017, and the entire contents of which are incorporated herein by reference.

### BACKGROUND

### Field of the Invention

The present invention relates to a communication electric wire having a twisted pair wire having a pair of conductor core wires spirally bundled together and to a wire harness configured using the communication electric wire.

### Description of Related Art

In an automobile wire harness or the like, a twisted pair wire having a pair of conductor core wires spirally bundled together has been used conventionally as a communication electric wire, for example, to connect a control device (an ECU or the like) to an electrical component. This kind of communication electric wire is generally designed so that the twisted pair wire has a predetermined characteristic impedance so as to satisfy, for example, required communication performance and noise countermeasure performance (EMC performance).

For example, in one of conventional communication electric wires, after a twisted pair wire is designed so as to have a predetermined characteristic impedance, a dielectric is disposed in the vicinity of the connection portion between the twisted pair wire and a connector so as to suppress the increase in the characteristic impedance due to the untwisting of the twisted pair wire at the connection portion.

As for details of the above protector, refer to JP 2016-045982 A.

### SUMMARY

When a communication electric wire is actually used, conductors are present in the vicinity of the communication electric wire in some cases, as in the case that the communication electric wire is bundled with other electric wires and in the case that the communication electric wire is disposed so as to make contact with metallic members. In such cases, the conductor core wires constituting the twisted pair wire are electromagnetically coupled with the conductors, and the characteristic impedance of the twisted pair wire may sometimes become lower than the design value thereof. The lowering of the characteristic impedance may cause fluctuations in the communication performance or the like of the communication electric wire, thereby being undesirable.

On the other hand, it is conceivable that a shield layer, such as a braided conductor, is provided so as to cover the twisted pair wire to suppress the lowering of the characteristic impedance. However, the manufacturing cost of the electric wire is raised by the addition of the shield layer to the communication electric wire.

An object of the invention is to provide a communication electric wire and a wire harness capable of suppressing fluctuations in the communication performance or the like of the communication electric wire and capable of lowering of the manufacturing cost of the communication electric wire.

Embodiments of the present invention provide the following items (1) and (2):

(1)

A communication electric wire comprising:

a twisted pair wire having a pair of conductor core wires spirally bundled together and a protection layer formed from resin and cylindrically covering an outer circumference of the twisted pair wire,

the twisted pair wire contacting with an inner face of the protection layer to eliminate its relative movement with respect to the protection layer in the direction orthogonal to the axial line of the communication electric wire,

the protection layer being configured to have a specific ratio of 1 or more, the specific ratio being a ratio of a thickness of a portion where the protection layer having the smallest thickness in a cross section orthogonal to the axial line of the communication electric wire to a distance between centers of the pair of the conductor core wires in the cross section.

(2)

A wire harness formed comprising: the communication electric wire according to claim 1; and one or more electric wires,

the communication electric wire and the electric wire being bundled together.

According to first aspect of the invention, relating to the item (1), the lowering of the characteristic impedance of the twisted pair wire can be suppressed even in the case that conductors are present in the vicinity of the communication electric wire, without using the above-mentioned shield layer. More specifically, according to the experiments and the like conducted by the inventors, in the case that the protection layer is provided so as to cover the outer circumference of the twisted pair wire and that the ratio of the thickness of the protection layer to the distance (the distance between the conductors) between the centers of the pair of conductor core wires is 1 or more (that is, the thickness of the protection layer is not less than the distance between the conductors), it has been found that the lowering of the characteristic impedance from the design value thereof is suppressed within an allowable range, regardless of the thickness of the conductor core wire of the twisted pair wire.

Furthermore, according to second aspect of the invention, relating to the item (2), even in the case that the communication electric wire is bundled with other electric wires so as to make close contact with them, the fluctuations in communication performance or the like of the communication electric wire can be suppressed because of the above-mentioned reason.

As the thickness of the protection layer is larger, the distance between the conductor core wires of the twisted pair wire and the conductors in the periphery of the communication electric wire becomes larger, and the influence of the peripheral conductors on the characteristic impedance becomes smaller. However, if the protection layer is made thicker thoughtlessly, the communication electric wire becomes thicker excessively and the handling of the communication electric wire becomes difficult. The communication electric wire configured as described above is herein particularly meaningful in that the communication electric wire can provide the optimal value of the thickness of the protection layer from the viewpoint of suppressing the lowering of the characteristic impedance and from the viewpoint of facilitating the handling of the communication electric wire. Furthermore, the communication electric wire is also meaningful in that the thickness of the protection layer for the conductor core wires having various kinds of thicknesses can be determined according to the same determination criteria.

Still further, in the case that the protection layer is mainly used to protect the twisted pair wire against impacts and the like from the outside (in the case of an ordinary protection layer), the protection layer is usually not required to be made thick to the extent of satisfying the condition (the ratio of the thickness of the protection layer to the distance between the conductors is 1 or more) of the thickness of the protection layer configured as described above. For example, in the case of a general protection layer, the ratio of the thickness of the protection layer to the distance between the conductors is approximately 0.4.

Accordingly, the communication electric wire and the wire harness configured as described above can suppress fluctuations in the communication performance or the like of the communication electric wire and can lower the manufacturing cost of the communication electric wire.

### Advantage of the Invention

As described above, the present invention can provide a communication electric wire and a wire harness capable of suppressing fluctuations in the communication performance or the like of the communication electric wire and capable of lowering of the manufacturing cost of the communication electric wire.

Several aspects of the invention have been described briefly above. The further details of the invention will be made clearer if the following description is read through with reference to the accompanying drawings.

### BRIEF DESCRIPTION OF THE DRAWINGS

FIG. 1 is a perspective view showing an electric wire according to an embodiment of the present invention;

FIG. 2 is a cross-sectional view taken on line A-A of FIG. 1, illustrating the dimensions of various portions of the electric wire shown in FIG. 1;

FIG. 3A is a cross-sectional view corresponding to FIG. 2 in the case that a plurality of other electric wires is bundled and disposed so as to extend in parallel with one another around the entire circumference of the electric wire shown in FIG. 1, and FIG. 3B is a graph showing the result of an experiment conducted to measure the relationship between the value “c/D” and the characteristic impedance of the twisted pair wire in the case shown in FIG. 3A; and

FIG. 4A is a cross-sectional view corresponding to FIG. 2 and showing an electric wire according to a modification of the embodiment of the present invention, and FIG. 4B is a cross-sectional view corresponding to FIG. 2 and showing an electric wire according to another modification of the embodiment of the present invention.

### DETAILED DESCRIPTION

### Embodiment

A communication electric wire 1 and a wire harness 2 according to an embodiment of the present invention will be described below referring to the accompanying drawings.

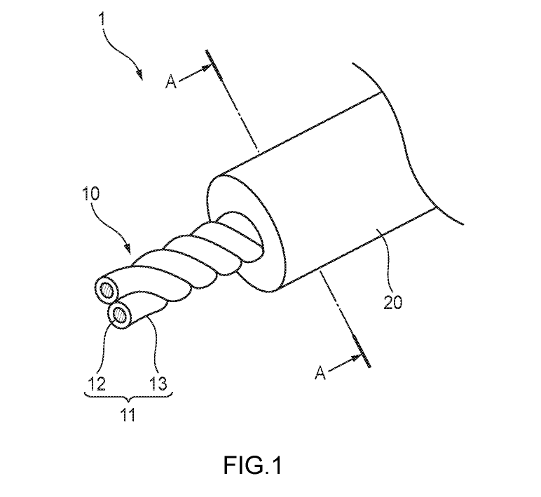

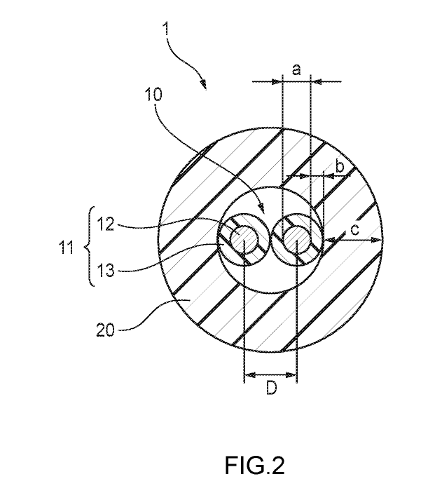

As shown in FIGS. 1 and 2, the communication electric wire 1 includes a twisted pair wire 10 having a pair of conductor core wires 11 spirally bundled together and a cylindrical (circularly cylindrical) protection layer 20 made of resin and covering the outer circumference of the twisted pair wire 10.

Each pair of conductor core wires 11 can be used typically to connect a control device (an ECU or the like) to an electrical component and to transmit a differential signal in an automobile wire harness or the like. Since the communication electric wire 1 has no shield layer on the outer circumference of the twisted pair wire 10, the communication electric wire 1 is more inexpensive than an electric wire having a shield layer on the outer circumference of the twisted pair wire thereof.

Each of the conductor core wires 11 constituting the twisted pair wire 10 has a linear conductor wire 12 and an insulation layer 13 made of resin and covering the conductor wire 12 so as to make contact with the outer circumference of the conductor wire 12. The pair of conductor core wires 11 is spirally twisted together. The twisted pair wire 10 makes contact with the inner face of the protection layer 20 so as to be relatively unmovable with respect to the protection layer 20 in the direction orthogonal to the axial line of the communication electric wire 1 (that is, in the in-plane direction of the cross section shown in FIG. 2). As a material constituting the conductor wire 12, a material containing copper, silver, tin, a silver alloy or a tin alloy is taken as an example. The specific method for forming the twisted pair wire 10 by twisting the pair of conductor core wires 11 is not limited particularly. For example, the pair of conductor core wires 11 may be twisted using a known twisting device or may be twisted by the manual work of a worker.

In this embodiment, as shown in FIG. 2, the protection layer 20 has an internal space, the shape of the cross section thereof orthogonal to the axial line of the communication electric wire 1 being circular. In this internal space, the twisted pair wire 10 is disposed in the state in which portions (both the end sections in the left-right direction in FIG. 2) of the outer circumferential face of the twisted pair wire 10 make contact with the inner face of the protection layer 20. At the portions other than the portions where the twisted pair wire 10 makes contact with the protection layer 20, a predetermined clearance is present between the inner face of the protection layer 20 and the twisted pair wire 10. The specific method for providing the protection layer 20 so as to cover the twisted pair wire 10 is not limited particularly. For example, the protection layer 20 can be provided by extrusion molding the cylindrical protection layer 20 so as to cover the twisted pair wire 10.

For convenience of explanation, as shown in FIG. 2, it is assumed that the diameter of the conductor wire 12 is a, that the thickness of the insulation layer 13 is b, that the thickness of the protection layer 20 is c, and that the distance between the conductors, that is, the distance between the centers of the pair of conductor core wires 11 in the cross section orthogonal to the axial line of the communication electric wire 1, is D. At this time, the distance D between the conductors can be calculated by “a +2b”.

The twisted pair wire 10 included in the communication electric wire 1 is generally designed to have a predetermined characteristic impedance so as to satisfy required communication performance and noise countermeasure performance (EMC performance), for example. The communication electric wire 1 having the twisted pair wire 10 that is designed as described above is used for automobile wire harnesses, for example. At this time, the communication electric wire 1 is used in some cases in the state in which other electric wires are bundled and disposed around the circumference of the communication electric wire 1, and the communication electric wire 1 is used in some cases in the state in which the communication electric wire 1 makes contact with metal members (vehicle body panels and the like) in the periphery of the communication electric wire 1. In the case that conductors (the conductor core wires of other electric wires, vehicle body panels, etc.) are present in the periphery of the twisted pair wire 10, the conductor wires 12 constituting the twisted pair wire 10 are electromagnetically coupled with the peripheral conductors, whereby the actual value of the characteristic impedance of the twisted pair wire 10 may become lower than the predetermined design value Z₀ in some cases. This lowering of the characteristic impedance may cause fluctuations in the communication performance or the like of the communication electric wire 1, thereby being undesirable.

It is known that a shield layer, such as a braided conductor, is provided around the outer circumference of the twisted pair wire to suppress the lowering of the above-mentioned characteristic impedance. However, the manufacturing cost of the electric wire including the twisted pair wire is raised by the cost of the added shield layer.

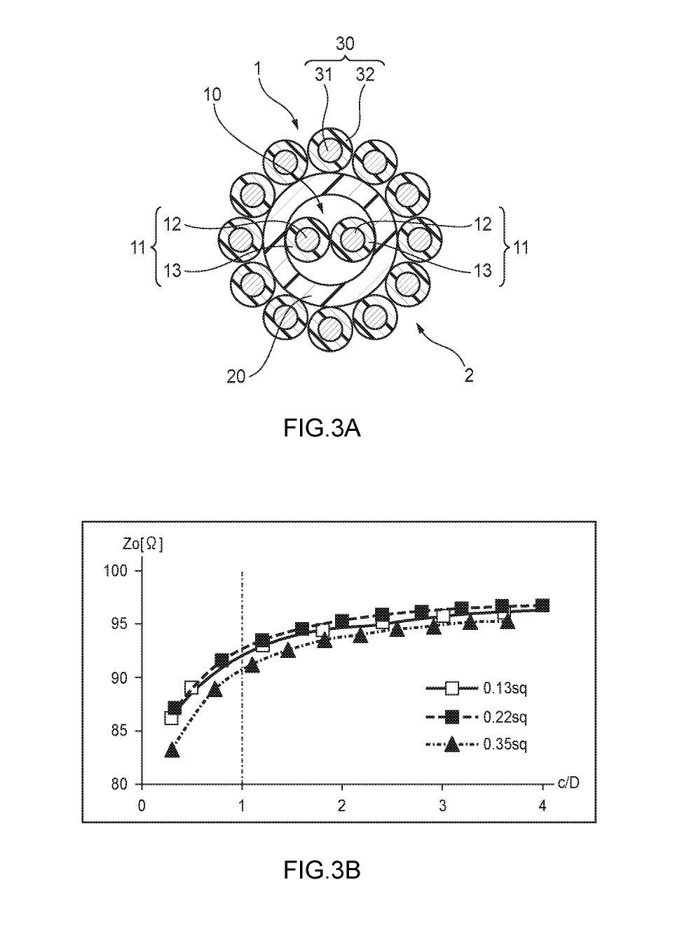

The inventors thus repeatedly conducted various experiments and the like to find out measures for suppressing the lowering of the above-mentioned characteristic impedance without additionally providing the shield layer. As a result, in the case that conductors are present in the periphery of the twisted pair wire 10, the inventors, by paying attention to the thickness c of the protection layer 20, have found that there is a strong correlation between the ratio (=c/D) of the thickness c of the protection layer 20 to the distance D between the conductors and the actual value of the characteristic impedance. The experiment having been conducted to clarify this correlation will be described below referring to FIGS. 3A and 3B.

First, three kinds of samples being different in thickness (corresponding to the diameter a) were prepared as the conductor wires 12 for use in the experiment. The thicknesses of the conductor wires 12 of the respective samples are 0.13, 0.22 and 0.35 sq mm. Furthermore, plural kinds of communication electric wires 1 having the twisted pair wires 10 including these conductor wires 12 and provided with the protection layers 20 being different in thickness c (that is, different in the value of c/D) were prepared. The cross section of the insulation layer 13 has a circularly cylindrical shape and the thickness b thereof is uniform regardless of the position in the circumferential direction.

For the purpose of providing conductors around the circumference of the communication electric wire 1, as shown in FIG. 3A, a plurality of other electric wires 30 was bundled and disposed so as to extend in parallel with one another around the entire circumference of the communication electric wire 1. As each of the other electric wires 30, an electric wire including a conductor core wire 31 having a thickness of 0.13 sq mm and an insulation layer 32 covering the conductor core wire 31 so as to make contact with the outer circumference of the conductor core wire 31 was used. The positional relationship between the communication electric wire 1 and the other electric wires 30 is based on the assumption that a wire harness 2 is in a state of being configured using the communication electric wire 1.

In this state, the characteristic impedances of the twisted pair wires 10 in the plural kinds of communication electric wires 1 were measured using a known method. In this embodiment, the twisted pair wires 10 are designed so that the characteristic impedance (design value) thereof is 100Ω.

As a result, as shown in FIG. 3B, in any of the three kinds of samples being different in the thickness of the conductor wire 12, in the case that the value c/D is less than 1, the increase gradient of the characteristic impedance with respect to the increase in the value c/D is relatively large, and in the case that the value c/D is 1 or more, the increase gradient of the characteristic impedance with respect to the increase in the value c/D is relatively small. In other words, the increase gradient of the characteristic impedance with respect to the increase in the value c/D changes significantly with the value c/D=1 used as a boundary.

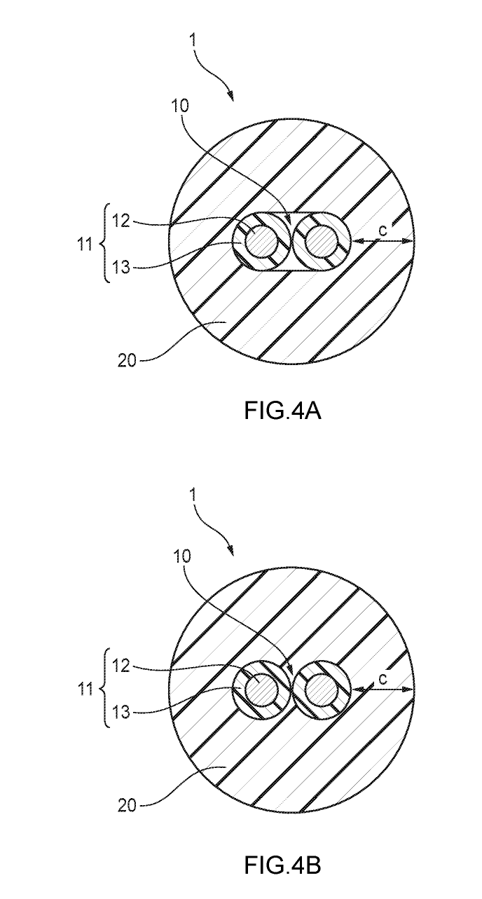

Furthermore, the inventors conducted a similar experiment for the communication electric wires 1 being different in the shape of the protection layer 20 as shown in FIGS. 4A and 4B. More specifically, the inventors conducted a similar experiment using an example in which the protection layer 20 has an internal space, the shape of the cross section of thereof orthogonal to the axial line of the communication electric wire 1 being a slot as shown in FIG. 4A, and using an example in which the protection layer 20 covers the circumference of the twisted pair wire 10 without any clearance as shown in FIG. 4B.

As a result, although not shown, in any of the examples shown in FIGS. 4A and 4B, a result similar to the result shown in FIG. 3B was obtained. More specifically, with respect to the thickness of the portion (indicated as the thickness c in the figures) where the thickness of the protection layer 20 is smallest, the increase gradient of the characteristic impedance with respect to the increase in the value c/D changes significantly with the value c/D=1 used as a boundary.

As described above, as the result of this experiment, with respect to the thickness c of the portion where the thickness of the protection layer 20 is smallest and the distance D between the conductors, in the case that the value c/D is less than 1 (that is, the thickness c of the protection layer 20 < the distance D between the conductors), the characteristic impedance is liable to lower significantly from the design value Z₀ due to the existence of the conductors in the periphery of the twisted pair wire 10. On the other hand, in the case that the value c/D is 1 or more (that is, the thickness c of the protection layer 20 ≥ the distance D between the conductors), it has been found that the lowering of the characteristic impedance from the design value Z₀ is easily suppressed within a predetermined allowable range (in this embodiment, within a range in which a characteristic impedance of 90% or more of the design value can be maintained) even in the case that conductors are present around the twisted pair wire 10, regardless of the thickness of the conductor wire 12 of the twisted pair wire 10 and without requiring a shield layer.

It is assumed that this phenomenon occurs because, if the thickness c of the protection layer 20 is not less than the distance D between the conductors (if the thickness c of the protection layer 20 is larger than the distance relatively and sufficiently), the electromagnetic coupling of the conductor wires 12 constituting the twisted pair wire 10 with the peripheral conductors (the conductor core wires 31 of the electric wires 30) is liable to be hindered and the lowering of the characteristic impedance is suppressed. However, if the protection layer 20 is made thicker thoughtlessly, the communication electric wire 1 becomes thicker excessively and the handling of the communication electric wire 1 becomes difficult. The present invention is herein particularly meaningful in that the present invention can provide the optimal value of the thickness of the protection layer 20 from the viewpoint of suppressing the lowering of the characteristic impedance and from the viewpoint of facilitating the handling of the communication electric wire 1. Furthermore, the present invention is also meaningful in that the thicknesses of the protection layers 20 for the conductor core wires 11 having various kinds of thicknesses can be determined according to the same determination criteria. Moreover, the upper limit value of the thickness c of the protection layer 20 can be determined, for example, in consideration of the handling (for example, bending rigidity and flexibility) of the communication electric wire 1.

As described above, with the communication electric wire 1 according to the embodiment of the present invention, the lowering of the characteristic impedance of the twisted pair wire 10 can be suppressed by adjusting the thickness c of the protection layer 20 covering the outer circumference of the twisted pair wire 10 without using a shield layer that is generally used. More specifically, in the case that the ratio (the value c/D) of the thickness c of the protection layer 20 to the distance (the distance between the conductors) D between the centers of the pair of conductor core wires 11 is 1 or more (that is, the thickness c of the protection layer 20 the distance D between the conductors), it has been found that the lowering of the characteristic impedance from the design value is suppressed within a predetermined allowable range even in the case that conductors are present around the twisted pair wire 10, regardless of the thickness of the conductor wire 12 of the twisted pair wire 10 and without requiring a shield layer.

### Other Embodiments

However, the present invention is not limited to the above-mentioned embodiments, but various modifications can be adopted within the scope of the present invention. For example, the present invention is not limited to the above-mentioned embodiments, but can be modified or improved as necessary. In addition, the materials, shapes, dimensions, quantities, arrangement positions, etc. of the respective components in the above-mentioned embodiments may be arbitrary and not limited, provided that the present invention can be achieved.

For example, in the above-mentioned embodiments, in any of the examples, the outer shape of the protection layer 20 is circular. However, the outer shape of the protection layer 20 may have other shapes (for example, an ellipse, a polygon, etc.), provided that the above-mentioned relationship between the thickness c of the portion where the thickness of the protection layer 20 is smallest and the distance D between the conductors is satisfied. Moreover, a wrapping member for maintaining the twisted shape of the twisted pair wire 10, an interposing substance for filling the internal space between the twisted pair wire 10 and the protection layer 20, etc. may be added to the communication electric wire 1 as necessary.

The characteristics of the communication electric wire 1 and the wire harness 2 according to the present invention described above will be briefly summarized and listed in the following items (1) and (2).

(1)

A communication electric wire (1) comprising:

a twisted pair wire (10) having a pair of conductor core wires (11) spirally bundled together and a protection layer (20) formed from resin and cylindrically covering an outer circumference of the twisted pair wire (10),

the twisted pair wire (10) contacting an inner face of the protection layer (20) to eliminate its relative movement with respect to the protection layer (20) in the direction orthogonal to the axial line of the communication electric wire (1), and

the protection layer (20) being configured to have a specific ratio of 1 or more, the specific ratio being a ratio (c/D) of a thickness (c) of a portion where the protection layer (20) having the smallest thickness in a cross section orthogonal to the axial line of the communication electric wire (1) to a distance (D) between centers of the pair of the conductor core wires (11).

(2)

A wire harness (2) comprising a communication electric wire (1) set forth in the above-mentioned item (1) and one or more electric wires,

the communication electric wire and the electric wire being bundled together.

### REFERENCE SIGNS LIST

1 communication electric wire
2 wire harness
10 twisted pair wire
11 conductor core wire
20 protection layer
c thickness of protection layer
D distance between conductors

1. A communication electric wire comprising:
a twisted pair wire having a pair of conductor core wires spirally bundled together and a protection layer formed from resin and cylindrically covering an outer circumference of the twisted pair wire,
the twisted pair wire contacting with an inner face of the protection layer to eliminate its relative movement with respect to the protection layer in the direction orthogonal to the axial line of the communication electric wire,
the protection layer being configured to have a specific ratio of 1 or more, the specific ratio being a ratio of a thickness of a portion where the protection layer having the smallest thickness in a cross section orthogonal to the axial line of the communication electric wire to a distance between centers of the pair of the conductor core wires in the cross section.

2. A wire harness formed comprising: the communication electric wire according to claim 1; and one or more electric wires,
the communication electric wire and the electric wire being bundled together.
